(19) United States
(12) Patent Application Publication
(10) Pub. No.: US 2025/0300195 A1
(43) Pub. Date: Sep. 25, 2025

(54) SEPARATOR OF FUEL CELL

(71) Applicant: TOYOTA JIDOSHA KABUSHIKI KAISHA, Toyota-shi (JP)

(72) Inventor: Toshiaki KUSAKARI, Sunto-gun (JP)

(73) Assignee: TOYOTA JIDOSHA KABUSHIKI KAISHA, Toyota-shi (JP)

(21) Appl. No.: 19/033,857

(22) Filed: Jan. 22, 2025

(30) Foreign Application Priority Data
Mar. 21, 2024 (JP) 2024-045640

(51) Int. Cl. H01M 8/0254

(52) U.S. Cl. CPC H01M 8/0254

(57) ABSTRACT

The separator includes a plurality of grooves for evacuating from the gas diffusion layer in the fuel cell to form a plurality of gas flow paths, a plurality of ribs for separating a plurality of gas flow paths in contact with the gas diffusion layer, and at least one first groove for evacuating from the gas diffusion layer and communicating only with the first flow path and extending toward the second flow paths on a contact surface in contact with the gas diffusion layer of at least one rib for separating the adjacent first and second flow paths of the plurality of gas flow paths.

### CROSS-REFERENCE TO RELATED APPLICATION

This application claims priority to Japanese Patent Application No. 2024-045640 filed on Mar. 21, 2024, incorporated herein by reference in its entirety.

### BACKGROUND

### 1. Technical Field

The present specification relates to a separator of a fuel cell.

### 2. Description of Related Art

For example, a fuel cell such as a polymer electrolyte fuel cell (PEFC) includes a stacked configuration in which multiple cells are stacked. A cell is formed of a membrane electrode gas diffusion layer composite (MEGA), in which a membrane electrode made of a polymer electrolyte membrane, an anode electrode, and a cathode electrode is further sandwiched by a gas diffusion layer, and a pair of separators. The separator has a corrugated cross-sectional region formed of ribs and grooves. The ribs protrude toward the gas diffusion layer side and come into contact with the gas diffusion layer, and the grooves form a flow path through which gas flows to the gas diffusion layer, by receding from the gas diffusion layer. The cell includes a plurality of flow paths of gas arranged in parallel.

Here, a device is disclosed that forms fine grooves on the surfaces of the ribs on the gas diffusion layer side, so as to communicate between adjacent flow paths (Japanese Unexamined Patent Application Publication No. 2020-47443 (JP 2020-47443 A)). JP 2020-47443 A describes that water easily generated when gas flows through the ribs can be captured and efficiently drained, by the fine grooves.

### SUMMARY

In JP 2020-47443 A, in the gas diffusion layer that faces and comes into contact with the ribs, diffusion of gas depends only on simple diffusion. Accordingly, gas diffusion in a direction toward a thickness direction of the gas diffusion layer (hereinafter, also called a face-down direction) on the surface of the gas diffusion layer facing the ribs (hereinafter, also called a rib surface) of the separator is still insufficient. It is desirable to improve a power generation efficiency by promoting gas diffusion in the rib surface and supplying gas more homogeneously through the gas diffusion layer.

The present specification provides technology that effectively diffuses gas in a face-down direction of a gas diffusion layer facing ribs of a separator, in a fuel cell.

The technology disclosed in the present specification is embodied in a separator of a fuel cell.

The separator includes
a plurality of grooves that recedes from a gas diffusion layer in the fuel cell to form a plurality of gas flow paths, and
a plurality of ribs in contact with the gas diffusion layer of the fuel cell to separate each of the gas flow paths.
   At least one first groove is provided on a contact surface of at least one rib separating an adjacent first flow path and second flow path of the gas flow paths, the contact surface coming into contact with the gas diffusion layer, and the at least one first groove receding from the gas diffusion layer and extending toward the second flow path by only communicating with the first flow path.

According to the separator, gas flows into the first groove from the first flow path toward the second flow path. Since the first flow path communicates only with the first flow path, an inflow to the second flow path is shut off. Gas that has flowed in but has been shut off from flowing out is diffused in a face-down direction of the gas diffusion layer that faces the shut-off portion. As a result, gas diffusion and/or convection in a face-down direction and an in-plane direction of the gas diffusion layer that faces the ribs is promoted.

Gas is uniformly supplied to the entire gas diffusion layer, and a power generation efficiency and a power generation performance of the fuel cell are improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating an overview of a single cell of a fuel cell disclosed herein;

FIG. 2A is an enlarged cross-sectional view of a dotted square frame I in FIG. 1;

FIG. 2B is a cross-sectional view of a 2B-2B line in FIG. 2A;

FIG. 3A is an enlarged cross-sectional view showing another embodiment of the dotted square frame I in FIG. 1; and

FIG. 3B is a diagram showing a cross section of 3B-3B line in FIG. 3A.

### DETAILED DESCRIPTION OF EMBODIMENTS

One embodiment herein is a separator of a fuel cell. The separator of the fuel cell includes a plurality of grooves that is evacuated from the gas diffusion layer and form a plurality of gas flow paths in the fuel cell, and a plurality of ribs that contacts the gas diffusion layer of the fuel cell and separate the plurality of gas flow paths. At least one first groove is provided on a contact surface of at least one rib separating an adjacent first flow path and second flow path of the gas flow paths, the contact surface coming into contact with the gas diffusion layer, and the at least one first groove receding from the gas diffusion layer and extending toward the second flow path by only communicating with the first flow path.

Another embodiment of the separator further includes at least one second groove that retracts from the gas diffusion layer and communicates only with the second flow path and extends toward the first flow path. In this way, the gas flows from the second flow path into the second groove, but is diffused in the face-down direction of the gas diffusion layer facing the blocking portion where the flow into the first flow path is blocked. As a result, gas diffusion and/or convection in a face-down direction and an in-plane direction of the gas diffusion layer that faces the ribs is promoted.

Another embodiment of the separator includes the at least one first groove and the at least one second groove opposite in a width direction along a width of the at least one rib. By doing so, the flow of gas is blocked at the center portion in the width direction, which is between the first groove and the second groove that face each other. By blocking the flow of the gas at the center portion in the width direction, the diffusion of the gas is promoted from the surface (rib surface) of the gas diffusion layer facing the center portion of the rib toward the face-down direction of the gas diffusion layer. This promotes gas diffusion and/or convection in the face-down direction and in-plane direction of the gas diffusion layer facing the rib.

In another embodiment, a plurality of sets of the at least one first groove and the at least one second groove is provided along a flow direction of gas in the first flow path and the second flow path, and the at least one first groove and the at least one second groove face each other in a width direction of the rib. A third groove is provided between the plurality of sets adjacent to each other along a flow direction of the gas and is retracted from the gas diffusion layer and is blocked from the first flow path, the second flow path, the first groove, and the second groove in a center portion in a width direction of the rib. By doing so, the gas diffused in the face-down direction of the rib surface through the first groove and the second groove is further diffused in the in-plane direction to reach the third groove in the center portion in the rib width direction. The gas reaching the third groove is again diffused in the face-down direction of the rib surface. By providing the first to third grooves, gas diffusion and/or convection in a face-down direction of the gas diffusion layer facing the rib and in the in-plane direction is promoted.

The separator of the other embodiment is arranged such that the at least one first groove and the at least one second groove are alternately arranged in a gas flow direction in the first flow path and the second flow path, and overlap the at least one first groove in a width direction of the at least one rib. In this way, the flow of the gas in the first groove is blocked at the end portion of the rib on the second flow path side, and the flow of the gas in the second groove is blocked at the end portion of the first flow path side. By blocking the flow of the gas at the end portion in the width direction of the rib, diffusion and/or convection of the gas is promoted from the surface (rib surface) of the gas diffusion layer facing the end portion of the rib toward the face-down direction of the gas diffusion layer.

One embodiment of the fuel cell disclosed herein includes a separator in any of the above. According to such a fuel cell, the gas is supplied more uniformly throughout the gas diffusion layer. Therefore, the power generation efficiency and the power generation performance of the fuel cell to which the gas is supplied by the gas diffusion layer are improved.

The fuel cell in the present specification is not particularly limited, and may be, for example, a polymer electrolyte fuel cell (PEFC).

### First Embodiment

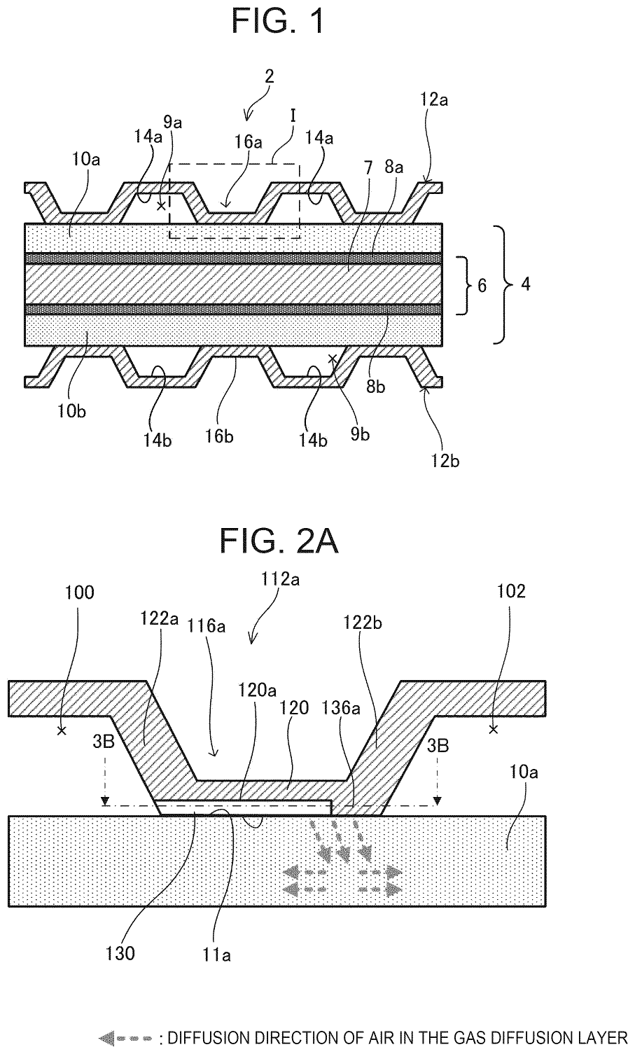

Embodiments of separators of fuel cells disclosed in the present specification will be described below, referring to the drawings as appropriate. FIG. 1 shows an outline of a cell 2 of a fuel cell.

FIG. 1 shows a membrane electrode gas diffusion layer complex (MEGA: Membrane Electrode & Gas Diffusion Layer Assembly) 4 constituting a cell 2 of a fuel cell that is a PEFC, and a pair of separators 12a, 12b sandwiching MEGA 4.

MEGA 4 includes a membrane-electrode assembly (hereinafter, also referred to as MEA: Membrane Electrode Assembly) 6 and gas diffusion layers 10a, 10b disposed on both surfaces thereof. MEA 6 includes an electrolyte membrane 7 and a pair of electrodes 8a, 8b bonded to sandwich the electrolyte membrane 7. The electrolyte membrane 7 is, for example, a proton-conductive ion exchange membrane formed of a solid polymer material. The electrode 8a, 8b are an air electrode (cathode) and a fuel electrode (anode), respectively, each of which is made of a known material. The gas diffusion layer 10a, 10b is formed of a conductive member such as a carbon porous material having gas permeability. The gas diffusion layer 10a is an air diffusion layer which is an example of an oxidizing gas, and the gas diffusion layer 10b is a hydrogen diffusion layer which is an example of a fuel gas.

The pair of separators 12 is, for example, a plate-shaped member having a stainless steel base material. The separators 12a, 12b have a corrugated configuration and face the gas diffusion layers 10a, 10b of MEGA 4, respectively.

The separator 12a includes a plurality of grooves 14a which faces the gas diffusion layer 10a and evacuates from the gas diffusion layer 10a in parallel. Between the plurality of grooves 14a of the separator 12a, a rib 16a protruding toward the gas diffusion layer 10a and coming into contact with the gas diffusion layer 10a is provided. Each of the plurality of ribs 16a separates adjacent grooves 14a. The plurality of grooves 14a forms the air flow path 9a by the gas diffusion layer 10a and the rib 16a. In the cell 2, the air flow direction in the air flow path 9a is the same direction. In FIG. 1, a direction from the front to the back of the paper surface is a flow direction of air. The air flow direction can be appropriately set. For example, in the planar form of the gas diffusion layer 10a, the gas diffusion layer may be provided so as to swirl or meander.

The surface of the separator 12a that is not opposed to the gas diffusion layer 10a is not particularly limited, but is appropriately subjected to a surface-treatment film, and is bonded to, for example, the separator 12b of the other cells 2 that are adjacently stacked.

The separator 12b includes a plurality of grooves 14b which faces the gas diffusion layer 10b and evacuates from the gas diffusion layer 10b in parallel. Between the plurality of groove 14b, a rib 16b protruding toward the gas diffusion layer 10b and coming into contact with the gas diffusion layer 10b is provided. Each of the plurality of ribs 16b separates adjacent grooves 14b. The plurality of grooves 14b forms a hydrogen-flow path 9b by the gas diffusion layer 10b and the rib 16b. In the cell 2, the flow direction of hydrogen in the hydrogen flow path 9b is the same direction. In FIG. 1, a direction from the back side to the front side is a flow direction of hydrogen. Note that the flow direction of hydrogen can be appropriately changed as in the case of air. The surface of the separator 12b that does not face the gas diffusion layer 10b is joined to the separator 12a of the other cells 2 that are adjacently stacked, similarly to the separator 12a.

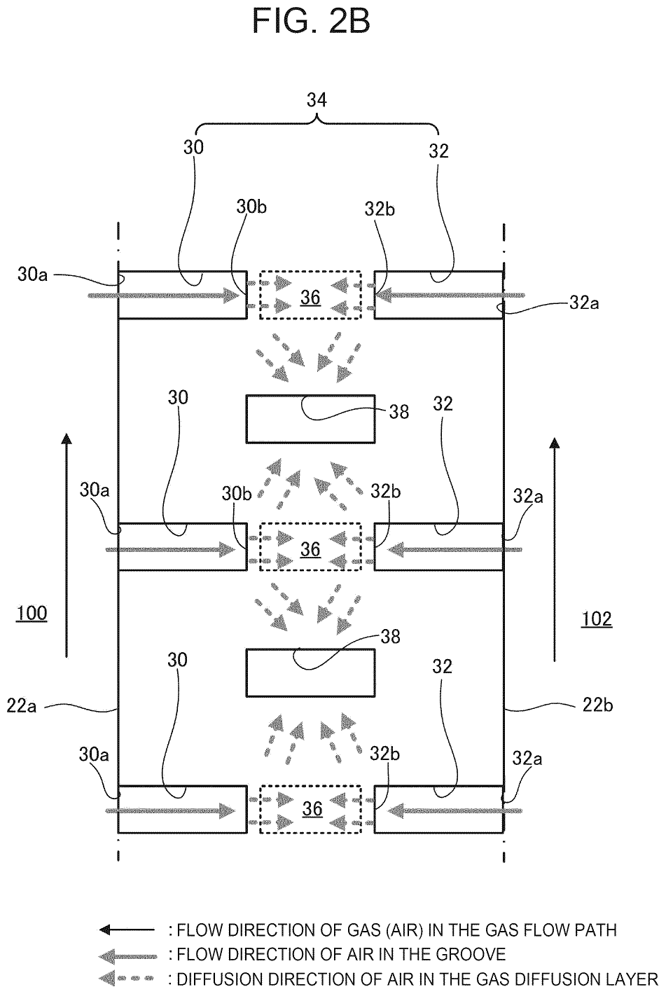

FIG. 2A and FIG. 2B are views illustrating the first groove 30, the second groove 32, and the third groove 38 in the rib 16a. FIG. 2A shows an enlarged square frame I surrounded by a dotted line in FIG. 1, FIG. 2B shows a 2B-2B line cross-section of the FIG. 2A.

As shown in FIG. 2A, the rib 16a includes a contact portion 20 facing the gas diffusion layer 10a, and side wall 22a, 22b constituting wall portions of the air flow paths 100 and 102 which are part of the air flow path 9a on both sides thereof. The surface 20a of the contact portion 20 facing the gas diffusion layer 10a includes a first groove 30, a second groove 32, and a third groove 38. The air flow paths 100 and 102 are examples of the first flow path and the second flow path in the present specification.

As shown in FIG. 2A and FIG. 2B, the first grooves 30 are provided on the surface 20a so as to be evacuated from the gas diffusion layer 10a. The first groove 30 extends along the width direction of the rib 16a in the side wall 22a of the rib 16a from the opening 30a opening toward the flow path 100 toward the flow path 102. The end 30b of the first groove 30 is formed at a position where it does not reach the flow path 102. The first groove 30 extends to about 30% of the width direction length of the rib 16a. The extension length of the first groove 30 is not particularly limited, but may be formed over a length less than 50% of the width direction length of the rib 16a.

The second groove 32 is provided to face the first groove 30 in the width direction of the rib 16a. The second grooves 32 are provided on the surface 20a so as to be evacuated from the gas diffusion layer 10a. The second groove 32 extends along the width direction of the rib 16a in the side wall 22b of the rib 16a from the opening 32a opening toward the flow path 102 toward the flow path 100. The end 32b of the second groove 32 is formed at a position where it does not reach the flow path 100. The second groove 32 extends to about 30% of the width direction length of the rib 16a. The extension length of the second groove 32 is not particularly limited, but, like the first groove 30, may be formed over a length less than 50% of the width direction length of the rib 16a.

The end 30b of the first groove 30 and the end 32b of the second groove 32 face each other leaving a width direction center portion of the rib 16a to form a pair 34. The center portion of the rib 16a that separates the first groove 30 and the second groove 32 constituting the pair 34 serves as a blocking portion 36 that blocks the flow of the gas flowing in from the first groove 30 and the gas flowing in from the second groove. The pair 34 of the first groove 30 and the second groove 32 opposed to each other in the width direction of the rib 16a is arranged at a predetermined distance along the flow direction of the gases, which is also the extending direction of the rib 16a. Further, the blocking portion 36 is also formed at a predetermined distance from the center portion of the rib 16a.

The rib 16a is further provided with a third groove 38. The third groove 38 is formed between the pair 34 adjacent to each other in the extending direction of the rib 16a and includes a center portion in the width direction of the rib 16a. The third grooves 38 are provided on the surface 20a of the rib 16a so as to be retracted from the gas diffusion layer 10a. The third grooves 38 are not in communication with the air flow paths 100 and 102, the first grooves 30, and the second grooves 32, and are opened only toward the gas diffusion layer 10a. A plurality of third grooves 38 is formed between the plurality of pairs 34.

The shapes of the first groove 30, the second groove 32, and the third groove 38 are not particularly limited, but are formed as grooves that do not penetrate outside the cells 2 of the separator 12a. The patterns, cross-sectional shapes, and depths of the grooves 30, 32, and 38 may be the same or different, and are not particularly limited. Such grooves can be obtained by cutting, bending, or molding the separators 12a into the intended shapes.

Next, the first groove 30, the second groove 32 and the third groove 38 will be described the effectiveness achieved in the diffusion to the gas diffusion layer 10a of the air as an example of the oxidant gas.

As shown in FIG. 2A and FIG. 2B, when the air flows along the flow path 100 and 102 in a flow direction as the air flow path 9a, the air enters the rib 16a from the first groove 30 opened to the side wall 22a. In addition, the air enters the rib 16a from the second groove 32 that opens into the side wall 22b.

Further, as indicated by the dotted arrows in FIG. 2A and FIG. 2B of the drawings, the air that hits the blocking portion 36 at the end 30b, 32b of the first groove 30 and the second groove 32 is diffused from the rib surface toward the face-down direction in the vicinity of the blocking portion 36. As a result, the diffusion and/or convection of the air in the face-down direction of the blocking portion 36 is promoted. The air diffused in the face-down direction of the surface of the blocking portion 36 is further directed to the second groove 32, the first groove 30, and the third groove 38, and is diffused in the gas diffusion layer 10a.

In this way, even in the rib surface 11a of the gas diffusion layer 10a facing the rib 16a, air is diffused and/or convected in the face-down direction and the in-plane direction. In the present embodiment, the first groove 30 and the second groove 32 are provided to face each other in the width direction of the rib 16a, and the blocking portion 36 is provided in the center portion of the rib 16a, so that it is possible for the air to sink in the face-down direction around the center portion of the rib 16a.

Further, in the present embodiment, since the third groove 38 is provided in the width direction center portion of the rib 16a between the pair 34, the air is diffused from the terminals of the first groove 30 and the second groove 32 toward the third groove 38 with the gas diffusion layer 10a. This further promotes in-plane diffusion and/or convection of the gas diffusion layer 10a facing the center portion of the rib 16a in an in-plane direction and face-down direction.

As described above, according to the separator 12a of the present embodiment, diffusion and/or convection of air is promoted in the face-down direction and the in-plane direction of the gas diffusion layer 10a to which the rib 16a faces. As a consequence, the gas diffusion layer 10a is uniformly supplied with air, thereby improving the power generation efficiency and the power generation performance. The first groove 30, the second groove 32, and the third groove 38 may be beneficial because it may be difficult to uniformly feed the gas diffusion layer 10a as compared to hydrogen.

In the first embodiment, the first groove 30 and the second groove 32 are provided, but only one of them may be provided. Even if only one of the grooves is provided, the diffusion and/or convection of the air in the face-down direction of the gas diffusion layer 10a facing the width direction center portion of the rib 16a is promoted. Although the third groove 38 is provided, the third groove is not necessarily provided.

Although only the separator 12a has been described in the present embodiment, the same first groove 30, second groove 32, and third groove 38 can be formed in the rib 16b of the separator 12b. As a result, more uniform gas diffusion and/or convection can be promoted in the gas diffusion layer 10b of hydrogen, which is an exemplary fuel gas, and the power generation efficiency and power generation performance can be improved.

### Second Embodiment

In the embodiments, a separator 112a having the same configuration as that of the first embodiment will be described except that it has the first groove 130 and the second groove 132 and does not have the third groove. Note that, in the following description, a configuration having features in the present embodiment will be mainly described, and the same reference numerals are used for components common to those in the first embodiment as necessary, or description thereof will be omitted.

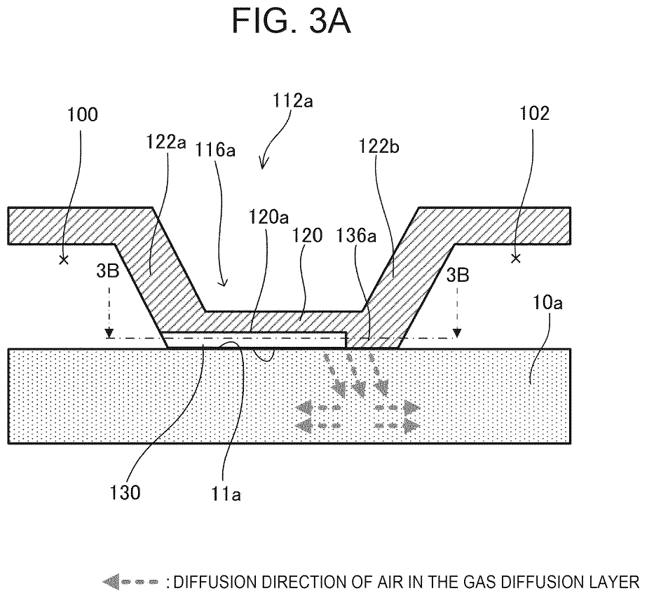

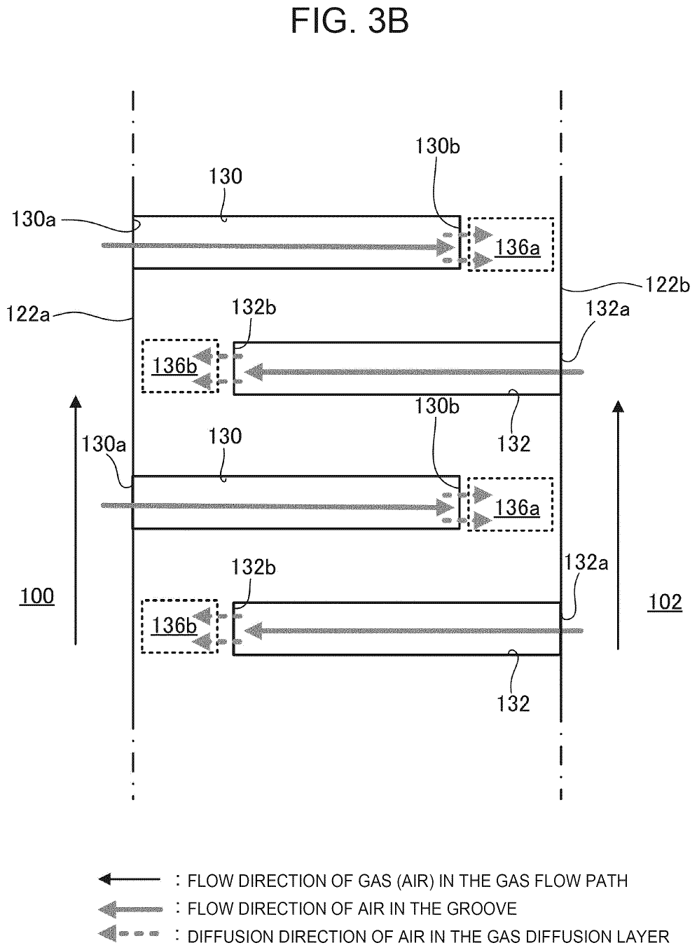

FIG. 3A and FIG. 3B are diagrams for describing the first groove 130 and the second groove 132 in the rib 116a of the separator 112a. FIG. 3A shows an enlarged part surrounded by a dotted line in FIG. 1 as the present embodiment, and FIG. 3B shows a cross-section taken along the line of 3B-3B in FIG. 3A.

As shown in FIG. 3A, the rib 116a includes a contact portion 120 facing the gas diffusion layer 10a, and side wall 122a, 122b forming wall portions of the air flow paths 100 and 102 on both sides thereof. A surface 120a of the contact portion 120 facing the gas diffusion layer 10a includes a first groove 130 and a second groove 132.

The first groove 130 is provided on the surface 120a so as to be evacuated from the gas diffusion layer 10a. The first groove 130 communicates with the flow path 100 from the opening 130a opening in the side wall of the rib 116a, and extends along the width direction of the rib 116a toward the flow path 102. Further, the end 130b of the first groove 130 is formed at a position where it does not reach the flow path 102. The first groove 130 extends more than half of the width direction length of the rib 116a. The extension length of the first groove 130 is not particularly limited, but may be formed over a length of 80% or less of the width direction length of the rib 116a.

The second groove 132 is provided so as not to face the first groove 130 in the width direction of the rib 116a, so as to be alternately with the first groove 130 in the flow direction of the gases and to overlap in the width direction. The second grooves 132 are also provided on the surface 120a so as to be evacuated from the gas diffusion layer 10a. The second groove 132 communicates with the flow path 102 from the opening 132a opening in the side wall 22b and extends toward the flow path 100. Further, the end 132b of the second groove 132 is formed at a position where it does not reach the flow path 100. The second groove 132 overlaps the first groove 130 in the width direction of the rib 116a by more than half of the length in the width direction of the rib 116a. The extension length of the second groove 132 is not particularly limited, but may be formed over a length of 80% or less of the width direction length of the rib 116a.

The first groove 130 and the second groove 132 are arranged at predetermined intervals along the gas flow direction in the flow paths 100 and 102, respectively, and alternately with each other. As a consequence, at the end portion of the rib 116a on the flow path 102 side, a blocking portion 136a that blocks the flow of the airflow flowing into the first groove 130 is formed at a predetermined distance. Further, at an end portion of the rib 116a on the flow path 100 side, a blocking portion 136b for blocking the flow of the airflow flowing into the second groove 132 is formed at a predetermined distance.

Next, the first groove 130, the second groove 132 will be described the effectiveness of achieving with respect to the diffusion of the gas diffusion layer 10a of the air as an exemplary oxidant gas.

As shown in FIG. 3A and FIG. 3B, when air flows along the gas flow direction through the flow paths 100 and 102 of the air flow path 9a formed in the cell 2, the air enters the rib 116a in the in-plane direction from the first groove 130 and the second groove 132 that are open to the side wall 122a, 122b.

Further, as indicated by the dotted arrows in FIG. 3A and FIG. 3B of the drawings, the air is applied to the blocking portion 136a, 136b at the end 130b, 132b of the first groove 130 and the second groove 132. As a consequence, the air is diffused downward in a face-down direction of the gas diffusion layer 10a facing the blocking portion 136a, 136b. As a consequence, it is promoted that the air diffuses and/or convects in the face-down direction of the blocking portion 136a, 136b.

Conventionally, there has been a tendency that it is difficult to diffuse air at the end portions of the rib 116a close to the flow channels 100 and 102. However, in the present embodiment, the first groove 130 and the second groove 132 are provided, and the blocking portion 136a, 136b is formed at the end portion in a face-down direction. As a consequence, the gas diffusion layer 10a can be supplied more uniformly, and the power generation efficiency and the power generation performance of the cell 2 are improved.

Although the separator 112a has been described in the present embodiment, the first groove 130 and the second groove 132 may be formed in the same configuration for the other pair of separators. By doing so, hydrogen can be supplied more uniformly in the gas diffusion layer 10b as an exemplary fuel gas, and the power generation performance of the cell 2 can be improved.

In the present embodiment, the first groove 130 and the second groove 132 are provided, but only one of them may be provided. The diffusion and/or convection of the air in a face-down direction of the gas diffusion layer 10a facing the one end of the rib 116a is promoted.

In the first embodiment and the second embodiment, although the different groove patterns in the rib 16a, 116a of the separator 12a, 112a have been described, these groove patterns may be combined as appropriate. For example, in the second embodiment, the third groove 38 may be further provided in the width direction center portion of the rib 116a. Further, in the plurality of rib 16a, 116a included in the separator 12a, 112a, the groove patterns of the first embodiment and the second embodiment may be combined for each rib or in one rib as appropriate.

What is claimed is:

1. A separator of a fuel cell, the separator comprising:
a plurality of grooves that recedes from a gas diffusion layer in the fuel cell to form a plurality of gas flow paths; and
a plurality of ribs that comes into contact with the gas diffusion layer to separate each of the gas flow paths, wherein at least one first groove is provided on a contact surface of at least one rib separating an adjacent first flow path and second flow path of the gas flow paths, the contact surface coming into contact with the gas diffusion layer, and the at least one first groove receding from the gas diffusion layer and extending toward the second flow path by only communicating with the first flow path.

2. The separator according to claim 1, further comprising at least one second groove that recedes from the gas diffusion layer and extends toward the first flow path by communicating only with the second flow path.

3. The separator according to claim 2, wherein the at least one first groove and the at least one second groove are provided facing each other in a rib width direction.

4. The separator according to claim 3,
wherein a plurality of sets of the at least one first groove and the at least one second groove is provided along a flow direction of gas in the first flow path and the second flow path, the at least one first groove and the at least one second groove facing each other in the rib width direction, and
wherein the first flow path, the second flow path, and a third groove recessed from the gas diffusion layer are provided in a center portion of the rib width direction between adjacent sets along the flow direction of the gas, the third groove being shut off from the first groove and the second groove.

5. The separator according to claim 2, wherein the at least one first groove and the at least one second groove are arranged to alternate in a gas flow direction in the first flow path and the second flow path and to overlap the at least one first groove in a width direction of the at least one rib.

6. A fuel cell comprising the separator according to claim 1.
